(19) United States
(12) Patent Application Publication
(10) Pub. No.: US 2022/0288877 A1
(43) Pub. Date: Sep. 15, 2022

(54) PREPARATION OF PATTERNED ANISOTROPIC-COMPRISING COMPOSITE MATERIALS

(71) Applicant: NATIONAL UNIVERSITY OF SINGAPORE, Singapore (SG)

(72) Inventors: Chuan Fu TAN, Singapore (SG); Ghim Wei HO, Singapore (SG)

(21) Appl. No.: 17/633,126

(22) PCT Filed: Aug. 5, 2020
(86) PCT No.: PCT/SG2020/050455

§ 371 Date: Feb. 4, 2022

(30) Foreign Application Priority Data
Aug. 5, 2019 (SG) 102019072335S

(51) Int. Cl. B29C 71/00; B29C 73/34; B29C 70/14; B33Y 10/00; B33Y 70/10; B29C 71/02

(52) U.S. Cl. CPC B29C 71/0072; B29C 73/34; B29C 70/14; B33Y 10/00; B33Y 70/10; B29C 71/02; B29K 2995/0044

(57) ABSTRACT

There is provided a method of forming a patterned anisotropic-comprising composite material, comprising inserting at least a part of a heated probe into a matrix to induce a local phase change around the probe within the matrix, the matrix being a matrix of thermo-reversible material and anisotropic fillers, and moving the heated probe within the matrix to form an alignment pattern of the anisotropic fillers comprised in the matrix. There is also provided a patterned anisotropic-comprising composite material formed from the method.

### TECHNICAL FIELD

The present invention relates to preparing patterned anisotropic-comprising composite materials.

### BACKGROUND

Materials composed of irreversibly-aligned micro-sized inorganic materials within a composite structure have many applications such as reinforced concrete, aerospace, turbines and bullet-proof vests. However, reconfiguration of these materials is not straightforward, requiring a series of energy-intensive industrial processes. Accordingly, these materials end up being disposed, contributing to waste which may therefore lead to further environmental problems.

Methods that do enable manipulation of orientations, such as digital printing to create a wide range of 3D architectures, however these methods do not allow localised spatial assembly of nano/microstructures. Further, the assemblies of the nano/microstructures may not be preserved after digital printing, or even if it is successful in doing so, the alignment is unidirectional and global.

There is therefore a need for an improved method of ordering and/or manipulating materials.

### SUMMARY OF THE INVENTION

The present invention seeks to address these problems, and/or to provide an improved method for preparing patterned anisotropic-comprising composite material and which enables reversible ordering-manipulation of the material.

According to a first aspect of the present invention, there is provided a method of preparing a patterned anisotropic-comprising composite material, the method comprising:
inserting at least a part of a heated probe into a matrix to induce a local phase change around the probe within the matrix, wherein the matrix is a matrix of thermo-reversible material and anisotropic fillers; and
moving the heated probe within the matrix thereby aligning the anisotropic fillers to form an alignment pattern of the anisotropic fillers comprised in the matrix.

In particular, the patterned anisotropic-comprising composite material may be a reconfigurable patterned anisotropic-comprising composite material.

The thermo-reversible material may be any suitable material suitable for the purposes of the present invention. According to a particular aspect, the thermo-reversible material may comprise any suitable material. In particular, the thermo-reversible material may comprise: a polymer, a polymer-derivative, a hydrocarbon-derivative, or a combination thereof. For example, the thermo-reversible material may be selected from, but is not limited to: elastomer, plastic, organogel, oleogel, hydrogel, aerogel, metal-organic gel, wax, or a combination thereof.

The anisotropic filler may be of any suitable material suitable for the purposes of the present invention. According to a particular aspect, the anisotropic fillers may comprise materials which are one-dimensional (1-D) or two-dimensional (2-D). For example, the anisotropic fillers may comprise, but is not limited to: 1-D homostructures, 1-D heterostructures, 2-D structures, or a combination thereof. In particular, the anisotropic fillers may comprise, but is not limited to, rods, tubes, wires, fibres, sheets, lamellars of carbon-based metal-based, oxide-based, chalcogen-based, organic-based, polymer- based materials, or a combination thereof.

The alignment pattern formed may be any suitable pattern. For example, the alignment pattern may be linear, non-linear, or a combination thereof. The alignment pattern may be controlled by adjusting: dimensions of the probe, temperature at which the probe is heated, speed at which the probe is moved during the movement, or a combination thereof.

According to another particular aspect, the method may further comprise:
removing the heated probe from the matrix; and
cooling the patterned anisotropic-comprising composite material.

The method may further comprise forming the matrix prior to the inserting, wherein the forming may comprise, but is not limited to: setting a mixture of thermo-reversible material and anisotropic filler in a mold, depositing and curing a mixture of thermo-reversible material and anisotropic filler on a substrate, or 3-dimensional (3D) printing an ink comprising a mixture of thermo-reversible material and anisotropic filler.

The method may further comprise reconfiguring the patterned anisotropic-comprising composite material. In particular, the reconfiguring the patterned anisotropic-comprising composite material may comprise heating the composite material above its phase-transition temperature.

According to a second aspect of the present invention, there is provided a patterned anisotropic-comprising composite material formed from the method according to the first aspect. The patterned anisotropic-comprising composite material may be a reconfigurable patterned anisotropic-comprising composite material.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1(a) shows a schematic representation of the method according to one embodiment of the present application and FIG. 1(b) shows a top down view of how the movement of the probe aligns the embedded anisotropic fillers in the matrix according to one embodiment of the present invention; and

FIG. 2 shows a cross-sectional alignment view of a 3D volumetric orientation assembly formed by layer-by-layer ordering during the ordering process.

### DETAILED DESCRIPTION

As explained above, there is a need for an improved method of preparing patterned anisotropic-comprising composite material and which enables reversible ordering- manipulation of the material.

In general terms, the present invention relates to a method based on localised phase transition to confine changes to nano/micromaterial orientation within a narrow convolution. By programming different travel paths of a manipulator, orientation of the nano/micromaterials may be altered, resulting in any combination of segmented linear and non-linear anisotropies. This results in the formation of a material system that may be finely controlled, comprising encoded nano/micromaterial orientation and have programmed functionalities. In particular, the method of the present invention may be automated, thereby avoiding a manual process of manipulation and assembly of nano/micromaterials. In this way, the process is highly controllable, reliable and reproducible according to a user specification.

According to a first aspect of the present invention, there is provided a method of preparing a patterned anisotropic-comprising composite material, the method comprising:
inserting at least a part of a heated probe into a matrix to induce a local phase change around the probe within the matrix, wherein the matrix is a matrix of thermo-reversible material and anisotropic fillers; and
moving the heated probe within the matrix, thereby aligning the anisotropic fillers to form an alignment pattern of the anisotropic fillers comprised in the matrix.

The patterned anisotropic-comprising composite material may be a reconfigurable patterned anisotropic-comprising composite material, as will be described below.

The thermo-reversible material may be any suitable material suitable for the purposes of the present invention. For the purposes of the present invention, a thermo-reversible material may be defined as a material which is reversibly transitioned between two phases. For example, the thermo-reversible material may be a material reversible with a reversible sol-gel phase, reversible between a solid and liquid phase, or a material reversible between a glassy and rubbery state, through application of heat.

The thermo-reversible material may comprise a material which is conductive, optically active or inactive, mechanically responsive, magnetic, or a combination thereof. For example, if the thermo-reversible material comprises a magnetic material, application of a magnetic field will allow localised magnetic domain alignment of the magnetic material.

According to a particular aspect, the thermo-reversible material may be a polymer, a polymer-derivative, a hydrocarbon-derivative, or a combination thereof. For example, the polymer may be selected from, but is not limited to: elastomer, plastic, organogel, oleogel, hydrogel, aerogel, metal-organic gel, wax, or a combination thereof. In particular, the thermo-reversible material may be, but not limited to: ethylene-vinyl acetate, carrageenan hydrogel, paraffin wax, or polyurethane.

The anisotropic filler may be any suitable material. For the purposes of the present invention, the anisotropic filler may be a direction-dependent material that is made up of unsymmetrical crystalline or non-crystalline structures and whose directional properties depend on the orientation and alignment of the material's structure.

The anisotropic filler may be a nanomaterial, a micromaterial, or a combination thereof. A nanomaterial may be defined as a material having at least one dimension in the nanoscale. Likewise, a micromaterial may be defined as a material having at least one dimension in the microscale.

According to a particular aspect, the anisotropic fillers may comprise materials which are one-dimensional (1-D) or two-dimensional (2-D) materials. In particular, the anisotropic fillers may comprise 1-D homostructures, 1-D heterostructures, 2-D structures, or a combination thereof.

The anisotropic fillers may be of any suitable material. For example, the anisotropic fillers may be, but is not limited to: carbon-based, metal-based, oxide-based, chalcogen-based, organic-based, polymer-based, or a combination thereof. The metal-based anisotropic fillers may comprise a transition metal-based anisotropic filler. In particular, the anisotropic fillers may comprise, but is not limited to, chalcogenides, carbon, graphene, graphene oxide, copper, silver, gold, cellulose, MXenes, or a combination thereof.

The anisotropic filler may be in any suitable form. For example, the anisotropic filler may be in the form of, but not limited to, rods, wires, tubes, sheets, fibres, lamellar structures, ribbons. In particular, the anisotropic filler may be in the form of, but not limited to, a nanorod, microrod, nanowire, microwire, nanotube, microtube, nanosheet, microheet, nanofiber, microfiber, nanolamellar structure, microlamellar structure, nanoribbon, microribbon, nanoparticle chain, microparticle chain, or a combination thereof. Even more in particular, the anisotropic filler may be, but not limited to, copper nanowires, carbon nanotubes, silver nanowires, gold nanotubes, cellulose nanofibers, graphene oxide nanosheets, molybdenum sulphide (MoS₂) nanosheets, or a combination thereof.

The matrix may be a matrix of a thermo-reversible material comprising anisotropic fillers. For example, the matrix may be composed of a thermo-reversible material as the medium of the matrix comprising anisotropic materials as fillers. In particular, the anisotropic material may be embedded within the thermo-reversible material. The matrix may be of any suitable shape, size and geometry.

According to a particular aspect, the method may further comprise forming the matrix prior to the inserting. The matrix may be formed by any suitable method. Non-limiting examples of methods of forming the matrix include: setting a mixture of thermo-reversible material and anisotropic filler in a mold, depositing and curing a mixture of thermo-reversible material and anisotropic filler on a substrate, or 3-dimensional (3D) printing an ink comprising a mixture of thermo-reversible material and anisotropic filler.

In particular, the matrix may be spun, casted, molded, 3D printed, or screen printed.

The probe used in the inserting may be any suitable probe. For example, the probe may be, but not limited to, a needle such as a solid needle or tubular needle, a rod, or a wire. The probe may comprise sensors. Various sensors may be used for different functions. For example, the sensor may be used for in-situ characterisation within the matrix when the probe is inserted into the matrix.

The probe may be a heated probe. Accordingly, the method may further comprise heating the probe prior to the inserting. The heating may comprise heating the probe to a pre-determined temperature. For example, the pre-determined temperature may be any temperature suitable to bring about a phase change in the thermo-reversible material. According to a particular aspect, the pre-determined temperature may be dependent on the thermo-reversible material comprised in the matrix.

The heating may be by any suitable means. For example, the heating may be by thermal conduction, or via a resistive wire or a suitable heating element.

The inserting may comprise inserting at least a part of the heated probe into the matrix. In particular, the inserting may comprise inserting at least a part of one or more heated probes into the matrix. When multiple probes are inserted into the matrix, the speed and scalability of the method may be improved.

The inserting may cause a localised phase transition of the matrix in the proximity of the probe, for example from a solid/gel/glassy phase to a liquid/sol/rubbery phase. In particular, the inserting causes increased localised fluidity in the matrix in the proximity of the probe. The advantage of such localised phase transition is that there can be greater control of the degree of phase change to be brought about to the material. This also enables internal minor defects within the matrix to be locally and readily fixed, without perturbing any remaining non-defective region.

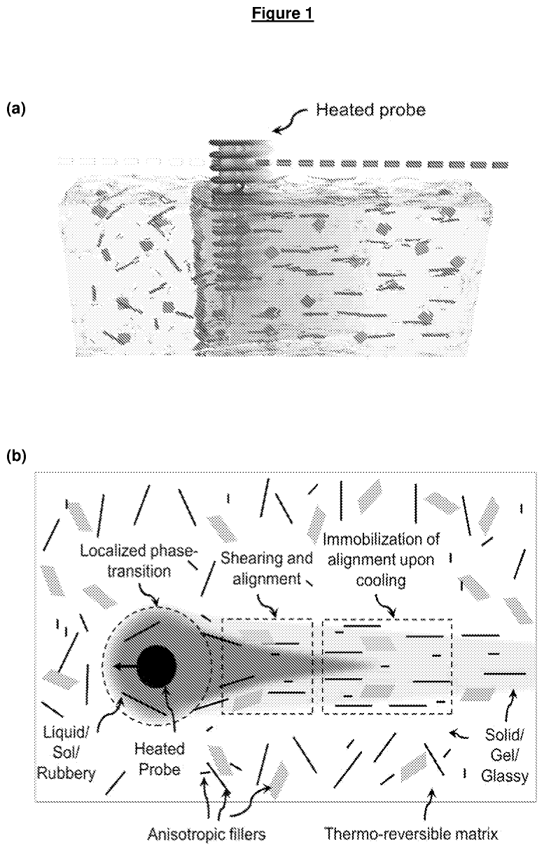

The moving of the probe within the matrix may form arbitrary linear and/or non-linear alignment patterns of the anisotropic materials within the matrix. In particular, the moving of the probe within the matrix may create a drag force which enables alignment of the anisotropic materials within the matrix. In particular, the embedded anisotropic materials may be aligned in the direction of the movement of the probe. FIGS. 1(a) and 1(b) show an example of the alignment of the anisotropic fillers. According to a particular aspect, the moving may be programmed to create arbitrary alignment patterns of linear and/or non-linear anisotropies.

The alignment pattern formed may be any suitable pattern. According to a particular aspect, the alignment pattern may be linear, non-linear, or a combination thereof. Examples of non-linear alignment patterns include, but is not limited to, concentric, azimuthal, radial, lateral, longitudinal, or a combination thereof. In particular, the alignment pattern may be non-linear alignment pattern, thereby enabling non-linear optical and/or electro-optical properties.

The alignment pattern may be unidirectional, bidirectional or multidirectional. In particular, the moving may enable segmented alignment directions of the anisotropic fillers down to micro/nano resolution, thereby achieving highly localised spatial ordering.

The alignment pattern may be controlled by adjusting: dimensions of the probe, temperature at which the probe is heated, speed at which the probe is moved during the movement, or a combination thereof. In particular, the scale and resolution of the alignment patterns may be adjusted based on the adjustments of the probe.

According to a particular aspect, the alignment pattern may be controlled and/or modified based on in-situ measurements made by the probe following the inserting and prior to the moving. In particular, sensors attached to the probe may be configured to make in-situ measurements and the information may be fed back to a control unit which may be configured to alter the movement pattern of the probe, thereby enabling a particular alignment pattern to be formed at a particular localised area within the matrix.

The method may further comprise:
removing the heated probe from the matrix after the moving; and
cooling the patterned anisotropic-comprising composite material.

Upon removing the heated probe and cooling the patterned anisotropic-comprising composite material, the alignment patterned of the anisotropic fillers formed during the moving may become set in place. The cooling may be by any suitable means and may comprise cooling the anisotropic-comprising composite material to a pre-determined temperature. The pre-determined temperature may be any suitable temperature and may be dependent on the anisotropic filler and thermo-reversible material comprised in the anisotropic-comprising composite material.

The method may further comprise reconfiguring the patterned anisotropic-comprising composite material. The reconfiguring may comprise reconfiguring the alignment pattern of a part of the patterned anisotropic-comprising composite material or may comprise reconfiguring the alignment pattern of the entire patterned anisotropic-comprising composite material. For example, the reconfiguring may comprise erasing a part or all of a prior alignment pattern of a patterned anisotropic-comprising composite material. The reconfiguring may further comprise overwriting a part or all of a prior alignment pattern following the erasing to a different alignment pattern. Alternatively, the reconfiguring may comprise direct overwriting a part or all of a prior alignment pattern to a different alignment pattern.

In particular, the reconfiguring may comprise heating the composite material above its phase-transition temperature. This may bring about thermal reformation of the alignment pattern of a patterned anisotropic-comprising composite material. Even more in particular, the reconfiguring may comprise repeating the inserting and moving described above. In this way, a different alignment pattern may be formed in the patterned anisotropic-comprising composite material.

The method of the present invention enables user-defined localized ordering of various functional anisotropic filler embedded within a thermo-reversible matrix. For example, a heated probe may be inserted into a matrix of thermo-reversible comprising anisotropic filler and moved in a first direction, thereby aligning a random configuration of the anisotropic fillers in the direction of the movement of the probe. Subsequent movement of the probe in a second direction in segmented regions of the matrix, overwrites the alignment of the anisotropic fillers to that of a second orientation. As a result, different properties (such as different degree of transmissions, in the case of an optical material) at different regions due to the different regional orientations of the anisotropic fillers may be achieved. Moreover, it is possible to overwrite the prevailing alignment by introducing the probe in the matrix again. As the whole process is reversible, different alignment patterns may be written over that of the initial alignment. The thermo-reversibility of the matrix also allows the entire form, shape, size of the composite material to be re-molded and changed to another construct by bulk heating above the phase-transition temperature. Accordingly, the method of the present invention enables reconfiguration of both the form as well as volumetric anisotropic properties of the composite material. In this way, a sustainable practice of recycling and upcycling of re-programming a material system for updated functions may be achieved.

The method of the present invention may also enable formation of three-dimensional (3D) segmented, volumetric anisotropies within a single system. For example, the method of the present invention may be applied layer-by-layer within a 3D anisotropic-comprising composite material. In particular, a first layer of an anisotropic-comprising composite material may be deposited or formed, following which patterning of the anisotropic-comprising composite material may be performed according to the method of the present invention, that is by inserting a heated probe and moving the heated probe within a matrix of the composite material. Subsequently, a second layer of an anisotropic-comprising composite material may be deposited or formed, which is then patterned as with the first layer. The depositing or forming of each layer may be by any suitable means. For example, the depositing or forming of each layer may be by 3D printing the layer.

Alternatively, layers within a 3D anisotropic-comprising composite material may be patterned by the method of the present invention by lifting the probe to pattern higher layers within the 3D material upon patterning the prior layer. In this way, deposition or formation of new layers may not be necessary.

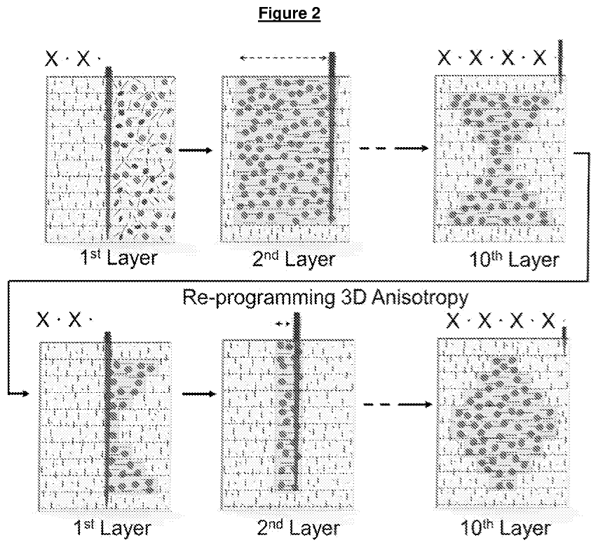

The alignment pattern of the first layer and the second layer may be the same or different. Likewise, additional layers may be deposited or formed with the same or different alignment patterns. Further, in view of the localised phase change nature of the method, forming an alignment pattern of one layer will not affect the alignment pattern formed in respect of another layer, even if the layers are adjacent to each other. In this way, an anisotropic-comprising composite material with a 3D segmented alignment system may be formed, which may be highly complex and easily customisable. An example is shown in FIG. 2. Subsequently, if it is desired to reconfigure the alignment patterns of each layer, thereby changing the properties of the composite material, the method of the present invention may be applied to each layer which is required to be reconfigured. This too is shown in FIG. 2. In particular, in the embodiment shown in FIG. 2, it can be seen that the anisotropic pattern of the composite material has been reconfigured from an hourglass shape to a diamond geometry.

The advantage of the reconfiguration aspect of the method of the present invention provides the ability for the method to be used in applications that require a change of state or material properties. For example, optical memory systems using the method of the present invention may be configured to allow the encoded memory to be altered when needed, as well as being able to have a change in memory type. According to one embodiment, it the method may enable a change in memory type from a 3D binary code to 2D multinary code. An optical memory formed from the anisotropic-comprising composite material prepared from the method of the present invention differs from the conventional memory storage by being soft, stretchable, and almost invariably hard to replicate anti-counterfeit feature with a unique optical spectrum originating from a combination of aligned anisotropic fillers comprised in the composite material.

Reversible mechanical anisotropy of a material may also be realized with a change in Young's modulus based on different alignments direction to suit the requirements at hand. Further, recycling of a fractured or undesired construct may be readily achieved by thermal reforming and application of the method of the present invention.

According to a second aspect of the present invention, there is provided a patterned anisotropic-comprising composite material formed from the method according to the first aspect.

In particular, the patterned anisotropic-comprising composite material may be a reconfigurable patterned anisotropic-comprising composite material. For example, the material may be reconfigured to erase a part or all of a prior alignment pattern of the patterned anisotropic-comprising composite material. The reconfiguration may comprise overwriting a part or all of a prior alignment pattern of the patterned anisotropic-comprising composite material.

The patterned anisotropic-comprising composite material formed may have the properties as described above in relation to the patterned anisotropic-comprising composite material formed from the method of the first aspect. The patterned anisotropic-comprising composite material formed may have many applications, such as in fields which require highly complex structures or customised materials. Other fields of application in which the patterned anisotropic-comprising composite material of the present invention may be used include, but is not limited to, non-linear optics or electro-optics for lasers, interaction with materials, display, sensors, actuators, information and storage technology, mechanical constructs, robotics and electronics.

Whilst the foregoing description has described exemplary embodiments, it will be understood by those skilled in the technology concerned that many variations may be made without departing from the present invention.

1. A method of preparing a patterned anisotropic-comprising composite material, the method comprising:
inserting at least a part of a heated probe into a matrix to induce a local phase change around the probe within the matrix, wherein the matrix is a matrix of thermo-reversible material and anisotropic fillers; and
moving the heated probe within the matrix, thereby aligning the anisotropic fillers to form an alignment pattern of the anisotropic fillers comprised in the matrix.

2. The method according to claim 1, further comprising:
removing the heated probe from the matrix; and
cooling the patterned anisotropic-comprising composite material.

3. The method according to claim 1, wherein the patterned anisotropic-comprising composite material is a reconfigurable patterned anisotropic-comprising composite material.

4. The method according to claim 1, wherein the thermo-reversible material comprises: a polymer, a polymer-derivative, a hydrocarbon-derivative, or a combination thereof.

5. The method according to claim 1, wherein the thermo-reversible material is selected from: elastomer, plastic, organogel, oleogel, hydrogel, aerogel, metal-organic gel, wax, or a combination thereof.

6. The method according to claim 1, wherein the anisotropic fillers comprise materials which are one-dimensional (1-D) or two-dimensional (2-D).

7. The method according to claim 6, wherein the anisotropic fillers comprise: 1-D homostructures, 1-D heterostructures, 2-D structures, or a combination thereof.

8. The method according to claim 1, wherein the anisotropic fillers comprise: rods, tubes, wires, fibres, sheets, lamellar structures of carbon-based, metal-based, oxide-based, chalcogen-based, organic-based, polymer-based materials, or a combination thereof.

9. The method according to claim 1, wherein the alignment pattern is linear, non-linear, or a combination thereof.

10. The method according to claim 1, wherein the alignment pattern is controlled by adjusting the: dimensions of the probe, temperature at which the probe is heated, speed at which the probe is moved during the movement, or a combination thereof.

11. The method according to claim 1, further comprising forming the matrix prior to the inserting, wherein the forming comprises: setting a mixture of thermo-reversible material and anisotropic filler in a mold, depositing and curing a mixture of thermo-reversible material and anisotropic filler on a substrate, or 3-dimensional (3D) printing an ink comprising a mixture of thermo-reversible material and anisotropic filler.

12. The method according to claim 1, further comprising reconfiguring the patterned anisotropic-comprising composite material.

13. The method according to claim 12, wherein the reconfiguring the patterned anisotropic-comprising composite material comprises heating the composite material above its phase-transition temperature.

14. A patterned anisotropic-comprising composite material formed from the method according to claim 1.

15. The patterned anisotropic-comprising composite material according to claim 14, wherein the material is a reconfigurable patterned anisotropic-comprising composite material.
